(19) United States
(12) Patent Application Publication
(10) Pub. No.: US 2005/0200258 A1
(43) Pub. Date: Sep. 15, 2005

(54) Surface light source device and back light unit having the same

(75) Inventors: Geun-Young Kim, Seoul (KR); Jae-Hyeon Ko, Suwon-si (KR); Ki-Yeon Lee, Suwon-si (KR); Dong-Woo Kim, Suwon-si (KR); Seog-Hyun Cho, Seoul (KR)

Correspondence Address: MAYER, BROWN, ROWE & MAW LLP, 1909 K STREET, N.W., WASHINGTON, DC, 20006, US

(73) Assignee: SAMSUNG CORNING CO., LTD.

(21) Appl. No.: 11/076,969

(22) Filed: Mar. 11, 2005

(30) Foreign Application Priority Data
Mar. 11, 2004 (KR) 10-2004-16398
Jun. 3, 2004 (KR) 10-2004-40195
Feb. 14, 2005 (KR) 10-2005-11950

(51) Int. Cl. H01K 1/18

(52) U.S. Cl. 313/292; 313/582

(57) ABSTRACT

A surface light source device includes a light source body having an inner space into which a discharge gas is injected, and an electrode for applying a voltage to the discharge gas. The light source body includes partition walls dividing the inner space into a plurality of discharge spaces. The partition walls have a width for suppressing formation of a parasite capacitance through which a current flows therein.

### CROSS-REFERENCE TO RELATED APPLICATION

This application claims priority under 35 USC § 119 to Korean Patent Applications Nos. 2004-16398, filed on Mar. 11, 2004, 2004-40195, filed on Jun. 3, 2004, and 2005-11950, filed on Feb. 14, 2005, the contents of which are herein incorporated by reference in their entireties for all purposes.

### BACKGROUND OF THE INVENTION

1. Field of the Invention

The present invention relates to a surface light source device and a back light unit having the same. More particularly, the present invention relates to partition walls dividing an internal space of a surface light source device into a plurality of discharge spaces, and a back light unit having the surface light source device as a light source.

2. Description of the Related Art

Generally, a liquid crystal (LC) has specific electrical and optical characteristics. In detail, when electric fields applied to the LC are changed, an arrangement of the LC molecules is also changed. As a result, an optical transmittance is altered.

A liquid crystal display (LCD) apparatus uses the above-explained characteristics of the LC to display an image. The LCD apparatus has many merits, for example, such as a small volume, a lightweight, etc. Therefore, the LCD apparatus is used in various fields, for example, such as a notebook computer, a mobile phone, a television set, etc.

The LCD apparatus includes a liquid crystal controlling part and a light providing part. The liquid crystal controlling part controls the LC. The light providing part provides the liquid crystal controlling part with a light.

The liquid crystal controlling part includes a pixel electrode formed on a first substrate, a common electrode formed on a second substrate and a liquid crystal layer interposed between the pixel electrode and the common electrode. A number of the pixel electrode is determined in accordance with resolution, and a number of the common electrode is one. Each of the pixel electrodes is electrically connected to a thin film transistor (TFT), so that a pixel voltage is applied to the pixel electrode through the TFT. A reference voltage is applied to the common electrode. Both of the pixel electrode and the common electrode include an electrically conductive and optically transparent material.

The light providing part provides the liquid crystal controlling part with a light. The light generated from the light providing part passes through the pixel electrode, the liquid crystal layer and the common electrode in sequence. Therefore, luminance and uniformity of the luminance have great influence on a display quality of the LCD apparatus.

A conventional light providing part employs a cold cathode fluorescent lamp (CCFL) or a light emitting diode (LED). The CCFL has a long cylindrical shape, whereas the LED has a small dot shape.

The CCFL has high luminance and long lifespan, and generates small amount of heat. The LED has a relatively high power consumption but a better color reproductibility. However, both of the CCFL and the LED have low uniformity of luminance.

Therefore, in order to enhance the luminance uniformity, the light providing part requires optical members such as a light guide plate (LGP), a diffusion member, a prism sheet, etc. Therefore, both of volume and weight of the LCD apparatus increase.

In order to solve above-mentioned problem, a surface light source device has been developed. FIG. 1 is a cross sectional view illustrating a conventional surface light source device.

Referring to FIG. 1, a conventional surface light source device includes a first substrate 1 and a second substrate 2 positioned over the first substrate 1. Partition walls 4 are arranged between the first substrate 1 and the second substrate 2. The partition walls 4 are arranged in parallel and spaced apart from each other by substantially same intervals to divide a space between the first and second substrates 1 and 2 into a plurality of discharge spaces 5 having a long cubic shape. A sealing member 3 is interposed between edge portions of the first substrate 1 and the second substrate 2 to isolate the discharge spaces from the exterior. A discharge gas is injected into the isolated discharge spaces. Electrodes 6 are formed on outer faces of the edge portions of the first substrate 1 and the second substrate 2.

To uniformly provide the discharge gas to the discharge spaces 5, the discharge spaces 5 are in communications with each other. For example, to provide passageways of the discharge gas to the partition walls 4, the partition walls 4 are arranged in a serpentine shape or holes are formed through the partition walls 4.

When a discharge voltage is applied to the discharge gas from the electrodes 6, the discharge gas generates ultraviolet light. The ultraviolet light is then converted into a visible light by fluorescent layers in the first and second substrates 1 and 2.

In the above-mentioned conventional surface light source device, only the discharge spaces 5 generate the visible light. Thus, portions of the first substrate 1 on the partition walls 4 function as a dark field deteriorating brightness of the surface light source device. Therefore, various studies for reducing an area of the partition walls 4 have been developed. In recent, a conventional surface light source device has partition wall having a width of no more than about 1 mm and thirty-seven discharge spaces.

Meanwhile, to improve luminance of the surface light source device, a current drift effect should be suppressed. When a potential difference is generated between adjacent discharge spaces, a current in a discharge space in which a relatively high voltage is generated is drifted into another discharge space in which a relatively low voltage is generated. This phenomenon is referred to as the current drift effect. The current drift effect lowers the luminance uniformity.

However, in the conventional surface light source device, as the partition walls have the width of no more than about 1 mm, an interval between adjacent discharge spaces is narrowed, which causes a parasite capacitance to be formed in the partition walls. A current flows to adjacent discharge spaces through the parasite capacitance so that the current drift effect is excessively generated. As a result, the luminance uniformity of the surface light source device is deteriorated.

Also, to improve a light-generating efficiency of the surface light source device, loss of plasma generated in the discharge spaces should be controlled. The loss of the plasma is caused from contacting the plasma with inner walls of the discharge spaces, which is ambipolar diffusion loss and is very important for controlling the electron energy distribution in the plasma.

However, the discharge space in the conventional surface light source device has an aspect ratio of no more than about 2:1. That is, the discharge space has a vertical length and a horizontal length of no more than about twice the vertical length. Thus, the plasma makes contact with side faces of the discharge space as well as upper and lower faces of the discharge space so that the plasma suffers excessive loss at the side faces and the upper and lower faces of the discharge space. As a result, the conventional surface light source device has a low light-generating efficiency.

### SUMMARY OF THE INVENTION

The present invention provides a surface light source device having an improved luminance by suppressing formation of a parasite capacitance in partition walls.

The present invention also provides a surface light source device including discharge spaces, which have an optimal aspect ratio established for optimizing loss of plasma, by reducing contact between the discharge spaces and the plasma.

The present invention still also provides a back light unit having the above-mentioned surface light source device.

A surface light source device in accordance with one aspect of the present invention includes a light source body having an inner space into which a discharge gas is injected, and an electrode for applying a voltage to the discharge gas. The light source body includes partition walls dividing the inner space into a plurality of discharge spaces. The partition walls have a width for suppressing formation of a parasite capacitor through which a current flows in the partition walls. The width may be about 3 mm to about 5 mm.

According to one embodiment, the light source body includes a first substrate, a second substrate positioned over the first substrate, and a sealing member interposed between edge portions of the first and second substrates to define the inner space. Additionally, a light-reflecting layer may be partially formed on portions of the second substrate, which are positioned on the partition walls.

According to another embodiment, the light source body includes a first substrate, and a second substrate having the partition walls and arranged over the first substrate. The partition walls are attached to the first substrate to form the discharge spaces. Additionally, a light-reflecting layer may be partially formed on the partition walls.

According to still another embodiment, the light source body includes a first substrate having the partition walls, and a second substrate arranged over the first substrates. The partition walls are attached to the second substrate to form the discharge spaces.

According to still another embodiment, the light source body includes a first substrate having first partition walls, and a second substrate having second partition walls and arranged over the first substrates. The first partition walls are attached to the second partition walls.

A surface light source device in accordance with another aspect of the present invention includes a light source body having an inner space into which a discharge gas is injected, and an electrode for applying a voltage to the discharge gas. The light source body includes partition walls dividing the inner space into a plurality of discharge spaces. A light-reflecting layer is formed on portions of the light source body corresponding to the partition walls.

A surface light source device in accordance with still another aspect of the present invention includes a light source body having an inner space into which a discharge gas is injected, and an electrode for applying a voltage to the discharge gas. The light source body includes partition walls dividing the inner space into a plurality of discharge spaces. The discharge spaces have an aspect ratio of about 2.5:1 to about 6:1. Also, the partition walls have a width for suppressing formation of the parasite capacitance through which a current flows in the partition walls. The width may be about 3 mm to about 5 mm.

A back light unit in accordance with still another aspect of the present invention includes a surface light source device, a case for receiving the surface light source device, an optical sheet interposed between the surface light source device and the case, and an inverter for applying a discharge voltage to the surface light source device. The surface light source device includes a light source body having an inner space into which a discharge gas is injected, and an electrode for applying a voltage to the discharge gas. The light source body includes partition walls dividing the inner space into a plurality of discharge spaces. The partition walls have a width for suppressing formation of the parasite capacitance through which a current flows in the partition walls.

According to the present invention, the partition walls have the width for suppressing formation of the parasite capacitance in the partition walls so that the current drift effect generated between the adjacent discharge spaces may be remarkably reduced. Thus, the surface light source device may be improved luminance. Also, the discharge spaces have the aspect ratio of about 2.5:1 to about 6:1. That is, the discharge spaces have a height and a width of about 2.5 times the height. Thus, the plasma may make contact with upper and lower faces of the discharge spaces without making contact with side faces of the discharge spaces so that the ambipolar diffusion loss of the plasma may be reduced for better lighting efficiency.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a cross sectional view illustrating a conventional surface light source device;

FIG. 2 is a cross sectional view illustrating a surface light source device in accordance with a first embodiment of the present invention;

FIG. 3 is an enlarged cross sectional view illustrating a portion III in FIG. 2;

FIG. 4 is a cross sectional view illustrating a surface light source device in accordance with a second embodiment of the present invention;

FIG. 5 is an enlarged cross sectional view illustrating a portion V in FIG. 4;

FIG. 6 is a cross sectional view illustrating a surface light source device in accordance with a third embodiment of the present invention;

FIG. 7 is an enlarged cross sectional view illustrating a portion VII in FIG. 6;

FIG. 8 is a cross sectional view illustrating a surface light source device in accordance with a fourth embodiment of the present invention;

FIG. 9 is an enlarged cross sectional view illustrating a portion IX in FIG. 8; FIG. 10 is an exploded perspective view illustrating a back light unit in accordance with a fifth embodiment of the present invention;

FIG. 11 is a picture illustrating a conventional surface light source device that is turned on; and

FIG. 12 is a picture illustrating the surface light source device in FIG. 4 that is turned on.

### DESCRIPTION OF EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of elements and regions may be exaggerated for clarity.

It will be understood that when an element or layer is referred to as being “on”, “connected to” or “coupled to” another element, it can be directly on, connected or coupled to the other element or layer or intervening elements may be present. In contrast, when an element is referred to as being “directly on,” “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiment 1

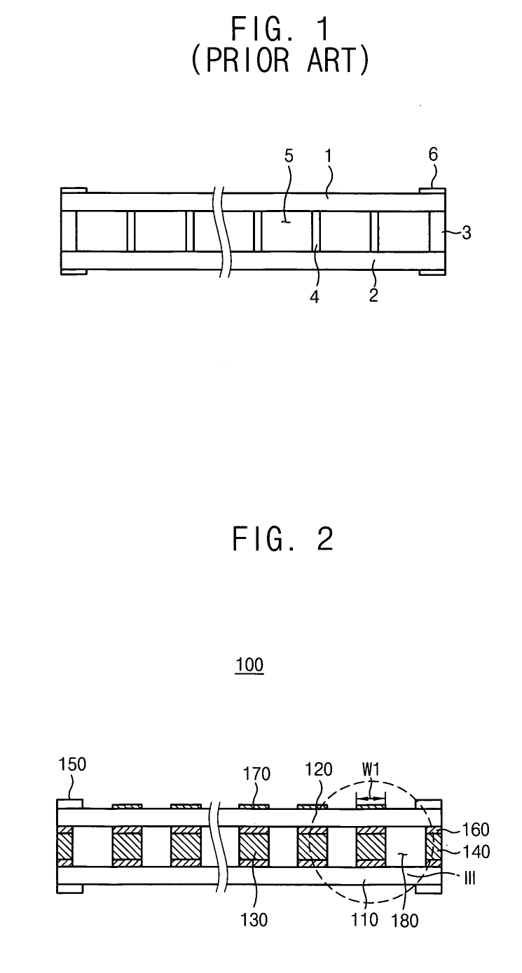

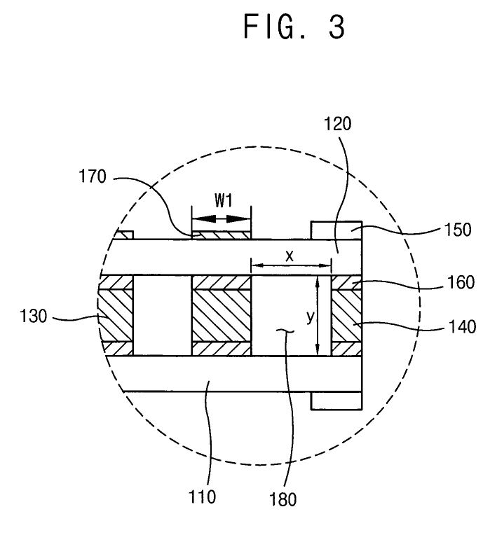

FIG. 2 is a cross sectional view illustrating a surface light source device in accordance with a first embodiment of the present invention and FIG. 3 is an enlarged cross sectional view illustrating a portion III in FIG. 2.

Referring to FIGS. 2 and 3, a surface light source device 100 in accordance with the present embodiment includes a light source body having an inner space into which a discharge gas is injected, and an electrode 150 for applying a voltage to the discharge gas. Here, examples of the discharge gas are a mercury gas, an argon gas, a neon gas, a xenon gas, etc.

The light source body is a partition wall-separated type. Thus, the light source body includes a first substrate 110 and a second substrate 120 positioned over the first substrate 110. A sealing member 140 is interposed between edge portions of the first and second substrates 110 and 120 to define the inner space. Partition walls 130 are arranged in the inner space to divide the inner space into discharge spaces 180 having a cubic cross section. Additionally, the light source body may include a fluorescent layer (not shown) and a light-reflecting layer (not shown).

The discharge spaces 180 have a width x and a height y. An aspect ratio of the discharge spaces 180, which corresponds to a ratio of the width x with respect to the height y, is about 2.5:1 to about 6:1. Preferably, the discharge spaces 180 have an aspect ratio of about 3:1 to about 5:1, more preferably about 3.5:1 to about 4.5:1. That is, the discharge spaces 180 have the width x relatively longer than that of discharge spaces in a conventional surface light source device. Thus, plasma generated in the discharge spaces 180 mainly makes contact with upper and lower faces of the discharge spaces 180. On the contrary, the plasma may not make contact with side faces of the discharge spaces 180. As a result, an amount of the plasma making contact with the side faces of the discharge spaces 180 may be reduced so that ambipolar diffusion loss of the plasma is suppressed and optimized for better lighting efficiency.

The first and second substrates 110 and 120 have a rectangular plate shape. Also, the first and second substrates 110 and 120 include a glass material for allowing a visible light to permeate and for blocking an ultraviolet ray. On the other hand, the partition walls 130 and the sealing member 140 are attached to the first and second substrates 110 and 120 using a frit 160.

The partition walls 130 are arranged substantially parallel with each other to form the discharge spaces 180 having a long cubic shape. To provide the discharge gas to each of the discharge spaces 180, the partition walls 130 are arranged in a serpentine shape. In particular, a first partition wall 130 has one end making contact with an inner wall of the sealing member 140 and the other end spaced apart from the inner wall of the sealing member 140. On the contrary, a second partition wall 130 adjacent to the first partition wall 130 has one end spaced apart from the inner wall of the sealing member 140 and the other end making contact with the inner wall of the sealing member 140. Thus, a path of the discharge gas forms the serpentine shape along the entire discharge spaces 180. Alternatively, a hole (not shown) through which the discharge gas flows may be formed through the partition walls 130.

Here, the partition walls 130 have a width W1. The width W1 of the partition walls 130 is determined to prevent a parasite capacitance from forming in the partition walls 130. When the width W1 of the partition walls 130 is below about 3 mm, the parasite capacitance is formed in the partition walls 130 so that a current drift effect is excessively generated. On the contrary, when the width W1 of the partition walls 130 is above about 5 mm, an area of a dark field is too large so that luminance of the surface light source device may be deteriorated. Thus, the width W1 of the partition walls 130 is preferably about 3 mm to about 5 mm, more preferably about 4 mm.

Here, the partition walls of the conventional surface light source device have the width of about 1 mm. Thus, the partition walls 130 of the surface light source device 100 in accordance with the present embodiment have the width W1 of four times that of the conventional partition walls. As a result, the discharge spaces 180 have a volume of about 0.2 to about 0.4 times that of the conventional discharge spaces. Also, numbers of the conventional discharge spaces are about thirty-seven. On the contrary, numbers of the discharge spaces 180 of the present invention are about twenty-eight.

Intervals between the discharge spaces 180 are widened due to the partition walls 130 having the width W1. Thus, the parasite capacitance through which the current flows may not be formed in the partition walls 130. As a result, since the current may not drift through the partition walls 130, the surface light source device 100 may have improved luminance.

In contrast, the volume of the discharge spaces 180 is reduced, while the width W1 of the partition walls 130 is widened. This may cause deterioration of the luminance of the surface light source device 100. However, a reduction rate of the luminance caused by the current drift effect may be relatively less than that of the luminance caused by the decrease of the volume of the discharge spaces 180. That is, a primary factor causing the deterioration of the luminance may be the current drift effect. Particularly, since the width W1 of the partition walls 130 is determined to suppress the current drift effect to the maximum and also to reduce the volume of the discharge spaces 180 to the minimum, the surface light source device 100 may have improved luminance.

To improve the luminance of the surface light source device 100 greater, light-reflecting layers 170 are partially formed on portions of the second substrate 120 corresponding to the dark fields. Thus, the light-reflecting layers 170 are positioned over the partition walls 130. As a result, the light-reflecting layers 170 are arrayed substantially parallel with each other in a direction substantially identical to that of the partition walls 130.

The light-reflecting layers 170 reflect a light, which orients toward the second substrate 120 by reflecting the light from a diffusion sheet (not shown) positioned over the second substrate 120, toward the diffusion sheet. Thus, an area of the dark fields caused by the partition walls 130 is reduced due to the light-reflecting layers 170. Here, examples of the light-reflecting layers 170 are titanium oxide, aluminum oxide, etc. Also, the light-reflecting layers 170 may be formed by a chemical vapor deposition (CVD) process, a spray coating process, a sputtering process, etc.

Here, the light-reflecting layers 170 may be employed in a surface light source device that includes partition walls having a width of about 1 mm as well as the surface light source device 100 that includes the partition walls 130 having the width W1.

Meanwhile, the electrode 150 may include a conductive tape or a metal powder that includes copper (Cu), nickel (Ni), silver (Ag), gold (Au), aluminum (Al), chrome (Cr), etc. The conductive tape is attached to an outer face of the light source body or the metal powder is coated on the outer face of the light source body to form the electrode 150.

Embodiment 2

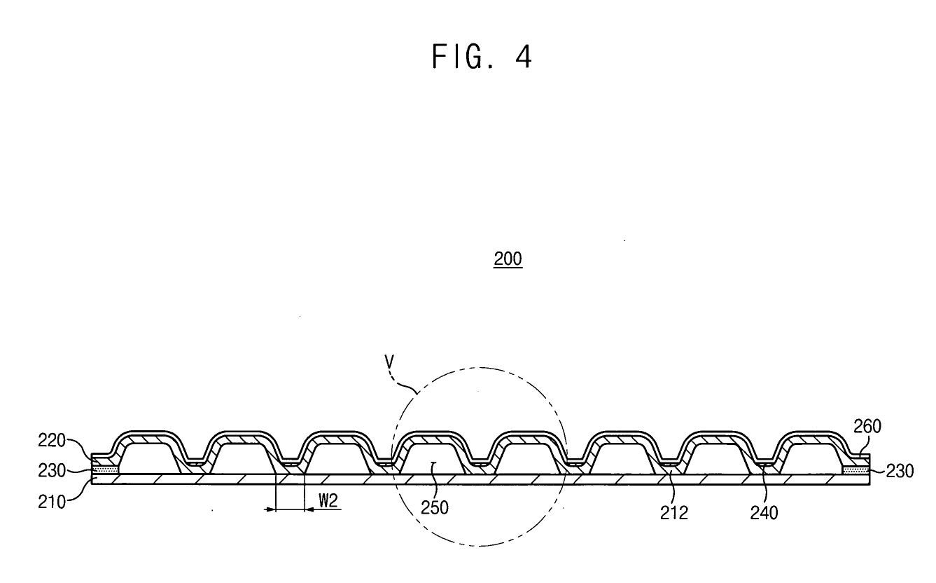

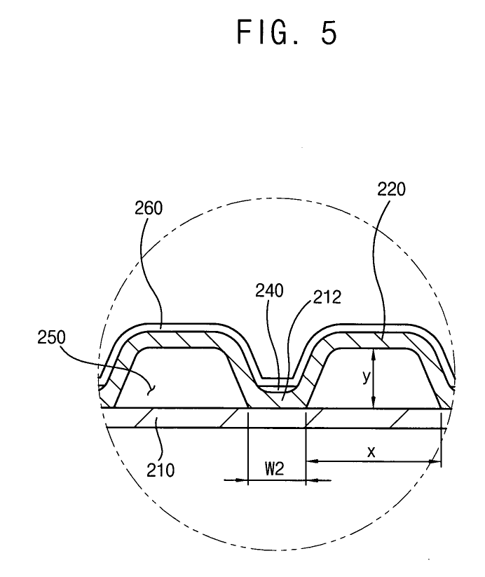

FIG. 4 is a cross sectional view illustrating a surface light source device in accordance with a second embodiment of the present invention and FIG. 5 is an enlarged cross sectional view illustrating a portion V in FIG. 4;

Referring to FIGS. 4 and 5, a surface light source device 200 in accordance with the present embodiment includes a light source body having an inner space into which a discharge gas is injected, and an electrode 260 for applying a voltage to the discharge gas.

The light source body is a partition wall-integrated type. Thus, the light source body includes a first substrate 210 and a second substrate 220 positioned over the first substrate 210. The second substrate 220 has partition wall portions 212 attached to an upper face of the first substrate 210 using a frit 230. Thus, a plurality of discharge spaces 250 having an arch cross shape is formed between the first and second substrates 210 and 220.

The electrode 260 is provided to an outer face of the light source body. Additionally, the light source body may include a fluorescent layer (not shown) and a light-reflecting layer (not shown). To provide the discharge gas to each of the discharge spaces 250, the partition wall portions 212 are arranged in a serpentine shape. Alternatively, a hole (not shown) through which the discharge gas flows may be formed through the partition wall portions 212.

The discharge spaces 250 have a width x and a height y. An aspect ratio of the discharge spaces 250, which corresponds to a ratio of the width x with respect to the height y, is about 2.5:1 to about 6:1. Preferably, the discharge spaces 250 have an aspect ratio of about 3:1 to about 5:1, more preferably about 3.5:1 to about 4.5:1. Effects shown by the aspect ratio of the discharge spaces 250 are illustrated in detail in Embodiment 1. Thus, any further illustrations of the aspect ratio are omitted herein.

The partition wall portions 212 have a width W2. The width W2 of the partition wall portions 212 is substantially identical to the width W1 of the partition walls 130 in Embodiment 1. Thus, any further illustrations with respect to the width W2 of the partition wall portions 212 are omitted herein.

Light-reflecting layers 240 are formed on the partition wall portions 212. The light-reflecting layers 240 have functions substantially identical those of the light-reflecting layers 170 in Embodiment 1. Thus, any further illustrations of the light-reflecting layers 240 are omitted herein.

Embodiment 3

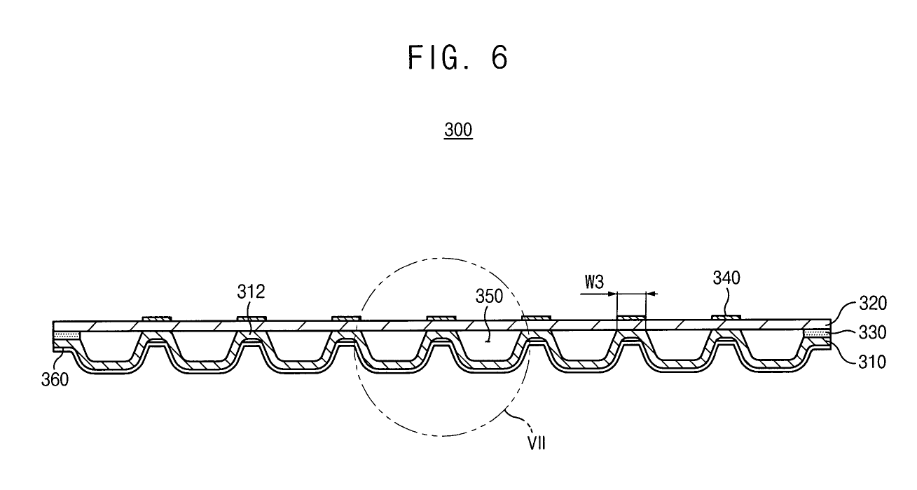

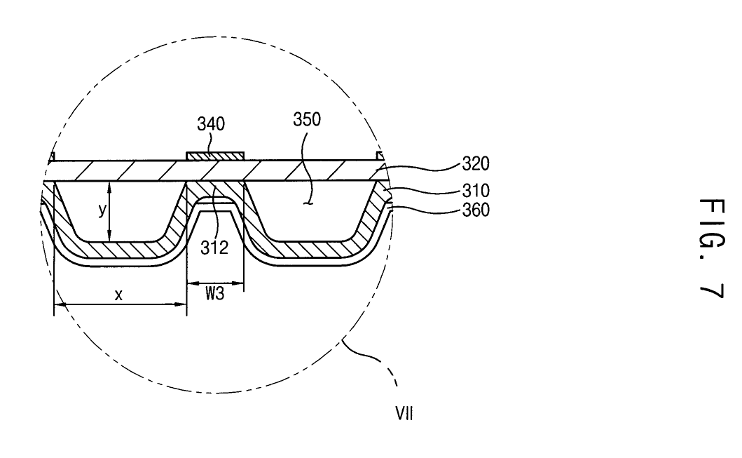

FIG. 6 is a cross sectional view illustrating a surface light source device in accordance with a third embodiment of the present invention and FIG. 7 is an enlarged cross sectional view illustrating a portion VII in FIG. 6;

Referring to FIGS. 6 and 7, a surface light source device 300 in accordance with the present embodiment includes a light source body having an inner space into which a discharge gas is injected, and an electrode 360 for applying a voltage to the discharge gas.

The light source body includes a first substrate 310 having partition wall portions 312 and a second substrate 320 positioned over the first substrate 310. The partition wall portions 312 are attached to a lower face of the second substrate 320 to form discharge spaces 350.

The discharge spaces 350 have a width x and a height y. An aspect ratio of the discharge spaces 350, which corresponds to a ratio of the width x with respect to the height y, is about 2.5:1 to about 6:1. Preferably, the discharge spaces 350 have an aspect ratio of about 3:1 to about 5:1, more preferably about 3.5:1 to about 4.5:1. Effects shown by the aspect ratio of the discharge spaces 350 are illustrated in detail in Embodiment 1. Thus, any further illustrations of the aspect ratio are omitted herein.

The partition wall portions 312 have a width W3. The width W3 of the partition wall portions 312 is substantially identical to the width W1 of the partition walls 130 in Embodiment 1. Thus, any further illustrations with respect to the width W3 of the partition wall portions 312 are omitted herein.

Light-reflecting layers 340 are formed on portions of the second substrate 320 corresponding to the partition wall portions 212. Since the partition wall portions 312 are arranged substantially parallel with each other, the light-reflecting layers 340 are arrayed substantially parallel with each other. The light-reflecting layers 340 have functions substantially identical those of the light-reflecting layers 170 in Embodiment 1. Thus, any further illustrations of the light-reflecting layers 340 are omitted herein.

Embodiment 4

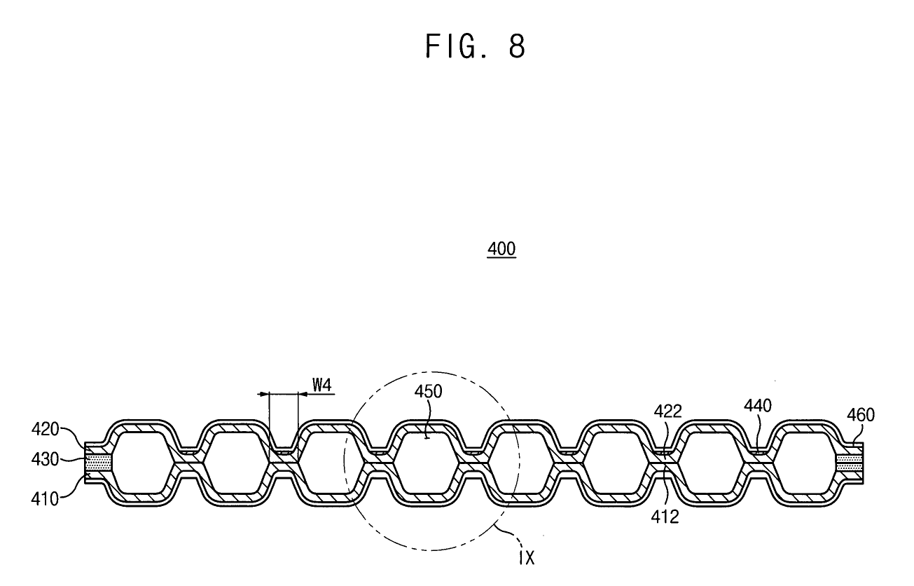

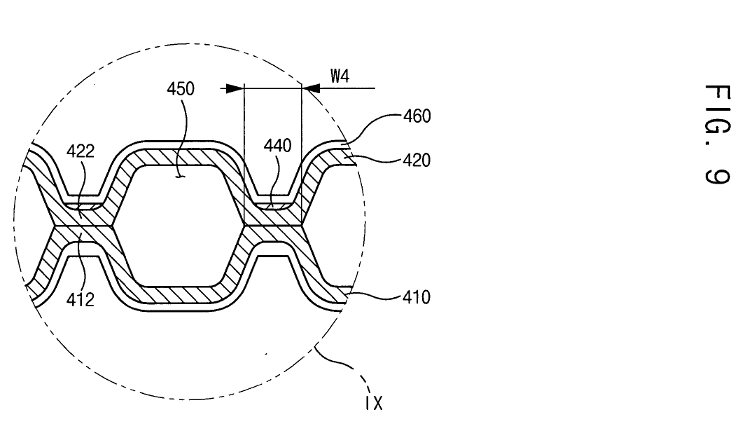

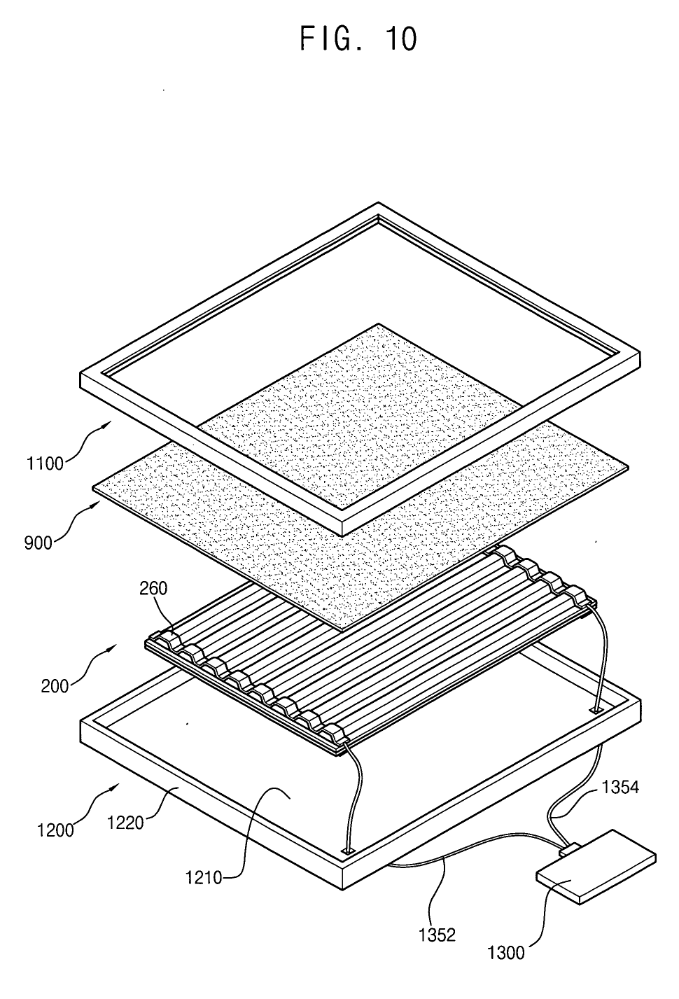

FIG. 8 is a cross sectional view illustrating a surface light source device in accordance with a fourth embodiment of the present invention and FIG. 9 is an enlarged cross sectional view illustrating a portion IX in FIG. 8.

Referring to FIGS. 8 and 9, a surface light source device 400 in accordance with the present embodiment includes a light source body having an inner space into which a discharge gas is injected, and an electrode 460 for applying a voltage to the discharge gas.

The light source body includes a first substrate 410 having first partition wall portions 412 and a second substrate 420 positioned over the first substrate 410 and having second partition wall portions 422. The first and second partition wall portions 412 and 422 have a semi-circular cross shape. Thus, the first and second partition wall portions 412 and 422 are attached to each other to form discharge spaces 450.

The first and second partition wall portions 412 and 422 have a width W4. The width W4 of the first and second partition wall portions 412 and 422 is substantially identical to the width W1 of the partition walls 130 in Embodiment 1. Thus, any further illustrations with respect to the width W4 of the first and second partition wall portions 412 and 422 are omitted herein.

Light-reflecting layers 440 are formed on portions of the second substrate 420. The light-reflecting layers 440 have functions substantially identical those of the light-reflecting layers 170 in Embodiment 1. Thus, any further illustrations of the light-reflecting layers 440 are omitted herein.

Embodiment 5

FIG. 10 is an exploded perspective view illustrating a back light unit in accordance with a fifth embodiment of the present invention;

Referring to FIG. 10, a back light unit 1000 in accordance with the present embodiment includes the surface light source device 200 in FIG. 4, upper and lower cases 1100 and 1200, an optical sheet 900 and an inverter 1300.

The surface light source device 200 is illustrated in detail with reference to FIG. 4. Thus, any further illustrations of the surface light source device 200 are omitted. Also, other surface light source devices in accordance with other Embodiments may be employed in the back light unit 1000.

The lower case 1200 includes a bottom face 1210 for receiving the surface light source device 200, and a side face 1220 extending from an edge of the bottom face 1210. Thus, a receiving space for receiving the surface light source device 200 is formed in the lower case 1200.

The inverter 1300 is arranged under the lower case 1200. The inverter 1300 generates a discharge voltage for driving the surface light source device 200. The discharge voltage generated from the inverter 1300 is applied to the electrode 260 of the surface light source device 200 through first and second electrical cables 1352 and 1354.

The optical sheet 900 includes a diffusion sheet (not shown) for uniformly diffusing a light irradiated from the surface light source device 200, and a prism sheet (not shown) for providing straightforwardness to the light diffused by the diffusion sheet.

The upper case 1100 is combined with the lower case 1220 to support the surface light source device 200 and the optical sheet 900. The upper case 1100 prevents the surface light source device 200 from being separated from the lower case 1200.

Additionally, an LCD panel (not shown) for displaying an image may be arranged over the upper case 1100.

Measuring Luminance of a Surface Light Source Device in Accordance with Aspect Ratios

Luminance of the surface light source device in FIG. 2 was measured with varying aspect ratios of discharge spaces. A driving frequency was 10 kHz to 100 kHz. Measured luminance was shown in following Table 1.

TABLE 1

| | Aspect ratio | | | | | | |
|---|---|---|---|---|---|---|---|
| | 2.39 | 2.75 | 2.89 | 2.96 | 3.17 | 3.58 | 4.02 |
| Relative luminance | 64 | 61 | 62 | 81 | 97 | 94 | 100 |

In Table 1, the relative luminance refers to luminance of the surface light source device measured in case that luminance of the surface light source device having an aspect ratio of 3.94 under same consumption power is set up as 100. As shown in Table 1, when the aspect ratio is no more than 3:1, the relative luminance is no more than 80%. On the contrary, when the aspect ratio is no less than 3:1, the relative luminance is no less than 95%.

Therefore, it should be noted that plasma made contact with upper and lower faces of the discharge space, while did not make contact with side faces of the discharge space, thereby reducing loss of the plasma, if the aspect ratio is no more than 3:1. As a result, it was proved that the surface light source device having the aspect ration of no less than 3:1 had improved luminance.

Also, Luminance of the surface light source device in FIG. 4 was measured with varying aspect ratios of discharge spaces. A driving frequency was 10 kHz to 100 kHz. Measured luminance was shown in following Table 2.

TABLE 2

| | Aspect ratio | | | | | | |
|---|---|---|---|---|---|---|---|
| | 2.39 | 3.00 | 3.07 | 3.15 | 3.46 | 3.52 | 3.94 |
| Relative luminance | 65 | 88 | 93 | 93 | 96 | 99 | 100 |

As shown in Table 2, when the aspect ratio is 2.79:1, the relative luminance is 65%. On the contrary, when the aspect ratio is 3:1, the relative luminance is 88%. As the aspect ratio is increased, the relative luminance is proportionally increased. When the aspect ratio is 3.94:1, the relative luminance is 100%.

Therefore, it should be noted that plasma did not expand ay more in a width direction, when the aspect ratio was no less than 3:1. That is, it should be noted that the plasma made contact with upper and lower faces of the discharge space having the discharge space of no less than 3:1, while did not make contact with side faces of the discharge space. Thus, the surface light source device having the aspect ratio of no less than 2.5:1, preferably 3:1 might have improved light-generating efficiency.

On the contrary, when the aspect ratio is continuously increased, intervals between the discharge spaces are widened. Thus, intervals between light-emitting regions are widened so that the surface light source device may have non-uniform luminance. Therefore, the aspect ratio may be preferably no more than 6:1.

Test for Surface Light Source Devices

A mercury gas was injected into the conventional surface light source device that included partition walls having a width of 1 mm and thirty-seven units of discharge spaces. The conventional surface light source device was maintained at a temperature of −20° C. for 30 minutes. A power of 140 watts was applied to the mercury gas through an electrode of the conventional surface source device.

Also, a mercury gas was injected into the surface light source device of the present invention that included partition walls having a width of 4 mm and twenty-eight units of discharge spaces. The surface light source device was maintained at a temperature of −20° C. for 30 minutes. A power of 140 watts was applied to the mercury gas through an electrode of the surface source device.

FIG. 11 is a picture illustrating a conventional surface light source device that is turned on. As shown in FIG. 11, several discharge spaces are not turned on. It shall be noted that a parasite capacitance is formed in the partition wall having the width of 1 mm so that a current is drifted to adjacent discharge space through the parasite capacitance.

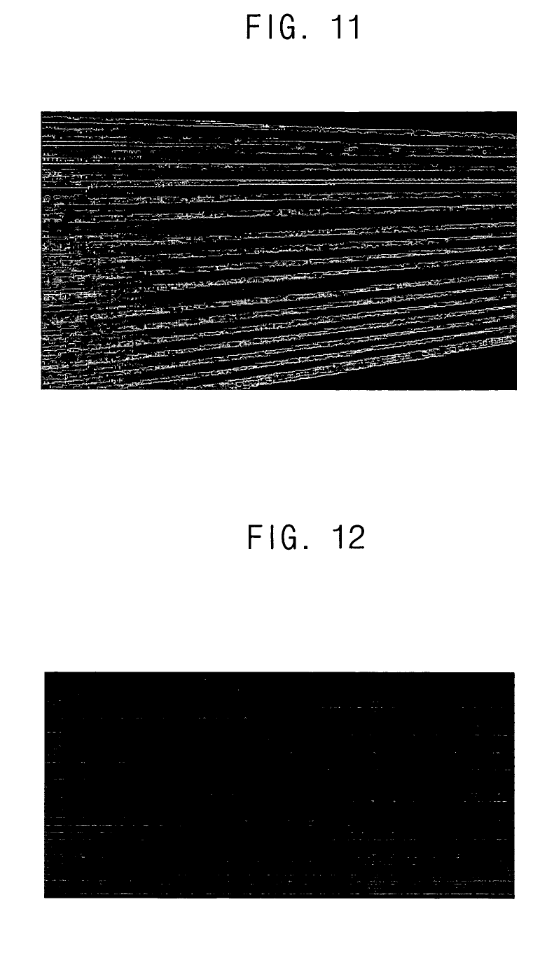

FIG. 12 is a picture illustrating the surface light source device in FIG. 4 that is turned on. As shown in FIG. 12, every discharge space is turned on. Thus, it shall be noted that a parasite capacitance is not formed in the partition wall having the width of 4 mm so that the current drift effect may not be generated in the surface light source device of the present invention.

As a result, since the parasite capacitance is not formed in the partition walls, the surface light source device that includes the partition walls having the width of 4 mm, although having an increased area of the dark field, may have improved luminance.

According to the present invention, the partition walls have the width of about three times that of conventional partition walls so that the parasite capacitance may not be formed in the partition walls. Thus, the current drift effect generated between the adjacent discharge spaces may be remarkably reduced. As a result, the surface light source device may have improved luminance.

Also, the light-reflecting layers are provided to positions corresponding to the partition walls so that the area of the dark field in the surface light source device may be reduced.

Further, the discharge spaces have the aspect ratio of about 2.5:1 to about 6:1. That is, the discharge spaces have a height and a width of about 2.5 times the height. Thus, the plasma may make contact with upper and lower faces of the discharge spaces without making contact with side faces of the discharge spaces so that the ambipolar diffusion loss of the plasma may be reduced and optimized for better lighting-generating efficiency.

Having described the exemplary embodiments of the present invention and its advantages, it is noted that various changes, substitutions and alterations can be made herein without departing from the spirit and scope of the invention as defined by appended claims.

1. A surface light source device comprising:
a light source body having an inner space into which a discharge gas is injected, and partition walls dividing the inner space into a plurality of discharge spaces, the partition walls having a width for suppressing formation of a parasite capacitance through which a current flows in the partition walls; and
an electrode for applying a voltage to the discharge gas.

2. The surface light source device of claim 1, wherein the partition walls have the width of about 3 mm to about 5 mm.

3. The surface light source device of claim 1, further comprising a light-reflecting layer formed on portions of the light source body corresponding to the partition walls.

4. The surface light source device of claim 1, wherein the light source body comprises:
a first substrate;
a second substrate positioned over the first substrate; and
a sealing member interposed between edge portions of the first and second substrates to define the inner space in which the partition walls are arranged.

5. The surface light source device of claim 1, wherein the light source body comprises:
a first substrate; and
a second substrate positioned over the first substrate and integrally formed with the partition walls, the partition walls being attached to the first substrate to form the discharge spaces.

6. The surface light source device of claim 1, wherein the light source body comprises:
a first substrate integrally formed with the partition walls; and
a second substrate positioned over the first substrates, the partition walls being attached to the second substrate to form the discharge spaces.

7. The surface light source device of claim 1, wherein the light source body comprises:
a first substrate integrally formed with first partition wall portions; and
a second substrate positioned over the first substrates and integrally formed with second partition wall portions, the second partition walls being attached to the first partition walls to form the partition walls.

8. The surface light source device of claim 1, wherein the discharge space has an aspect ratio of about 2.5:1 to about 6:1.

9. The surface light source device of claim 1, wherein the discharge space has an aspect ratio of about 3:1 to about 5:1.

10. The surface light source device of claim 1, wherein the discharge space has an aspect ratio of about 3.5:1 to about 4.5:1.

11. A surface light source device comprising:
a light source body including partition walls dividing an inner space into which a discharge gas is injected into a plurality of discharge spaces, and a light-reflecting layer formed on portions of an outer face of the light source body corresponding to the partition walls; and
an electrode for applying a voltage to the discharge gas.

12. The surface light source device of claim 11, wherein the light source body comprises:
a first substrate;
a second substrate positioned over the first substrate; and
a sealing member interposed between edge portions of the first and second substrates to define the inner space in which the partition walls are arranged.

13. The surface light source device of claim 11, wherein the light source body comprises:
a first substrate; and
a second substrate positioned over the first substrate and integrally formed with the partition walls, the partition walls being attached to the first substrate to form the discharge spaces.

14. The surface light source device of claim 11, wherein the light source body comprises:
a first substrate integrally formed with the partition walls; and
a second substrate positioned over the first substrates, the partition walls being attached to the second substrate to form the discharge spaces.

15. The surface light source device of claim 11, wherein the light source body comprises:
a first substrate integrally formed with first partition wall portions; and
a second substrate positioned over the first substrates and integrally formed with second partition wall portions, the second partition walls being attached to the first partition walls to form the partition walls.

16. The surface light source device of claim 11, wherein the discharge space has an aspect ratio of about 2.5:1 to about 6:1.

17. The surface light source device of claim 11, wherein the discharge space has an aspect ratio of about 3:1 to about 5:1.

18. The surface light source device of claim 11, wherein the discharge space has an aspect ratio of about 3.5:1 to about 4.5:1.

19. A surface light source device comprising:
a light source body including partition walls dividing an inner space into which a discharge gas is injected into a plurality of discharge spaces; and
an electrode for applying a voltage to the discharge gas,
wherein the discharge space has an aspect ratio of about 2.5:1 to about 6:1.

20. The surface light source device of claim 19, wherein the discharge space has an aspect ratio of about 3:1 to about 5:1.

21. The surface light source device of claim 19, wherein the discharge space has an aspect ratio of about 3.5:1 to about 4.5:1.

22. The surface light source device of claim 19, wherein the light source body comprises:
a first substrate;
a second substrate positioned over the first substrate; and
a sealing member interposed between edge portions of the first and second substrates to define the inner space in which the partition walls are arranged.

23. The surface light source device of claim 19, wherein the light source body comprises:
a first substrate; and
a second substrate positioned over the first substrate and integrally formed with the partition walls, the partition walls being attached to the first substrate to form the discharge spaces.

24. A surface light source device comprising:
a light source body having an inner space into which a discharge gas is injected, and partition walls dividing the inner space into a plurality of discharge spaces, the partition walls having a width of about 3 mm to about 5 mm; and
an electrode for applying a voltage to the discharge gas,
wherein the discharge space has an aspect ratio of about 2.5:1 to about 6:1.

25. A back light unit comprising:
a surface light source device including a light source body having an inner space into which a discharge gas is injected and partition walls dividing the inner space into a plurality of discharge spaces, the partition walls having a width for suppressing formation of a parasite capacitance through which a current flows in the partition walls, and an electrode for applying a voltage to the discharge gas;
a case for receiving the surface light source device;
an optical sheet interposed between the surface light source device and the case; and
an inverter for applying a discharge voltage to the electrode of the surface light source device.

26. The back light unit of claim 25, wherein the partition walls have the width of about 3 mm to about 5 mm.

27. The back light unit of claim 25, wherein the discharge space has an aspect ratio of about 2.5:1 to about 6:1.

28. The back light unit of claim 25, wherein the discharge space has an aspect ratio of about 3:1 to about 5:1.

29. The back light- unit of claim 25, wherein the discharge space has an aspect ratio of about 3.5:1 to about 4.5:1.
